(19) United States
(12) Patent Application Publication
(10) Pub. No.: US 2004/0195846 A1
(43) Pub. Date: Oct. 7, 2004

(54) Electromagnetic lock

(76) Inventor: Chih Chung Chang, Hsin Chuang City (TW)

Correspondence Address: Chih Chung Chang, P.O. Box 4-67, Hsin Chuang, Taipei, 242, TW

(21) Appl. No.: 10/408,084

(22) Filed: Apr. 4, 2003

(51) Int. Cl. E05B 15/02

(52) U.S. Cl. 292/340

(57) ABSTRACT

An electromagnetic lock includes an electromagnet having one or more stops slightly extended downward, an armature plate slidably received in a housing and having one or more openings and ramps to guide the stops to engage into the openings of the armature plate. One or more casings are secured to the armature plate, one or more guides are extended through the casings, and each has one end disposed between the casings and the armature plate, and the other end threaded with the housing. One or more springs may be biased between the armature plate and the housing, for biasing armature plate away from the housing and toward the electromagnet.

### BACKGROUND OF THE INVENTION

1. Field of the Invention

The present invention relates to an electromagnetic lock, and more particularly to an electromagnetic lock having a structure for smoothly operation purposes.

2. Description of the Prior Art

Various kinds of typical electromagnetic locks have been developed and comprise an electromagnet secured to either the door frame or the door panel, and an armature plate slidably or resiliently attached to the corresponding door panel or the door frame, for being attracted by the electromagnet, and for selectively locking the door frame and the door panel together.

For example, the applicant has developed an electromagnetic lock which has been allowed and issued as U.S. Pat. No. 6,260,892 to Chang. The electromagnetic lock includes one or more guide grooves formed in the armature plate for slidably receiving the corresponding projections from the electromagnet, and for guiding the projections of the electromagnet to engage into the corresponding guide grooves of the armature plate, and for allowing the door frame and the door panel to be effectively locked together.

However, the projections are directly and solidly extended from the electromagnet, and may not be retracted relative to the electromagnet, such that the projections of the electromagnet may not be smoothly guided to engage into the corresponding guide grooves of the armature plate.

U.S. Pat. No. 6,135,515 discloses another typical electromagnetic lock which includes an armature plate having two projections for engaging into the corresponding cavities of the electromagnet. However, the projections are also solidly extended from the armature plate, and may not be retracted relative to the armature plate, such that the projections of the armature plate also may not be smoothly guided to engage into the corresponding grooves of the electromagnet.

The present invention has arisen to mitigate and/or obviate the afore-described disadvantages of the conventional electromagnetic locks.

### SUMMARY OF THE INVENTION

The primary objective of the present invention is to provide an electromagnetic lock including an electromagnet having one or more spring-biased projections for smoothly engaging with the armature plate.

The other objective of the present invention is to provide an electromagnetic lock including an armature plate having one or more spring-biased guides for effectively engaging with the electromagnet.

In accordance with one aspect of the invention, there is provided an electromagnetic lock comprising an electromagnet, two stops provided in the electromagnet and slightly extended downwardly beyond the electromagnet, a housing including a chamber formed therein, an armature plate slidably received in the chamber of the housing, and including two openings formed therein, and including an upper portion having two pairs of ramps formed thereon and aligned with the openings thereof respectively, to engage with and to guide the stops of the electromagnet to engage into the openings of the armature plate respectively, two casings secured to the armature plate and aligned with the openings of the armature plate respectively, two guides extended through the casings respectively, and each including a first end disposed between the casings and the armature plate respectively, and each including a second end threaded with the housing, two springs engaged onto the guides respectively, and biased between the armature plate and the housing, for biasing armature plate away from the housing and toward the electromagnet.

The armature plate includes two cavities formed therein and communicating with the openings thereof respectively, and the stops each includes a head provided thereon and received in the cavities of the armature plate respectively.

The housing includes two fences provided on bottom thereof to define two recesses therein and to receive ends of the springs respectively.

The electromagnet includes two apertures formed therein to slidably receive the stops respectively, and two second springs engaged with the stops respectively, to bias the stops slightly downwardly beyond the electromagnet.

One or more pushers may further be provided and disposed in the armature plate and biased to engage with the electromagnet, for pushing the armature plate away from the electromagnet.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an electromagnetic lock in accordance with the present invention, illustrating the operation of the electromagnetic lock;

FIG. 2 is a partial exploded view of the electromagnetic lock;

FIG. 3 is an exploded view of an electromagnet of the electromagnetic lock;

FIG. 4 is an exploded view of an armature plate and a retaining housing of the electromagnetic lock;

FIG. 5 is a cross sectional view taken along 5-5 of FIG. 1, illustrating the operation of the electromagnetic lock;

FIGS. 6, 7, 8 are cross sectional views similar to FIG. 5, illustrating the operation of the electromagnetic lock;

FIG. 9 is a cross sectional view taken along 9-9 of FIG. 7;

FIG. 10 is an enlarged partial cross sectional view of the electromagnetic lock as shown in FIG. 9;

FIG. 11 is a cross sectional view similar to FIG. 9, illustrating the operation of the electromagnetic lock; and

FIG. 12 is an enlarged partial cross sectional view of the electromagnetic lock as shown in FIG. 11, illustrating the operation of the electromagnetic lock.

### DETAILED DESCRIPTION OF THE PREFERRED EMBODIMENT

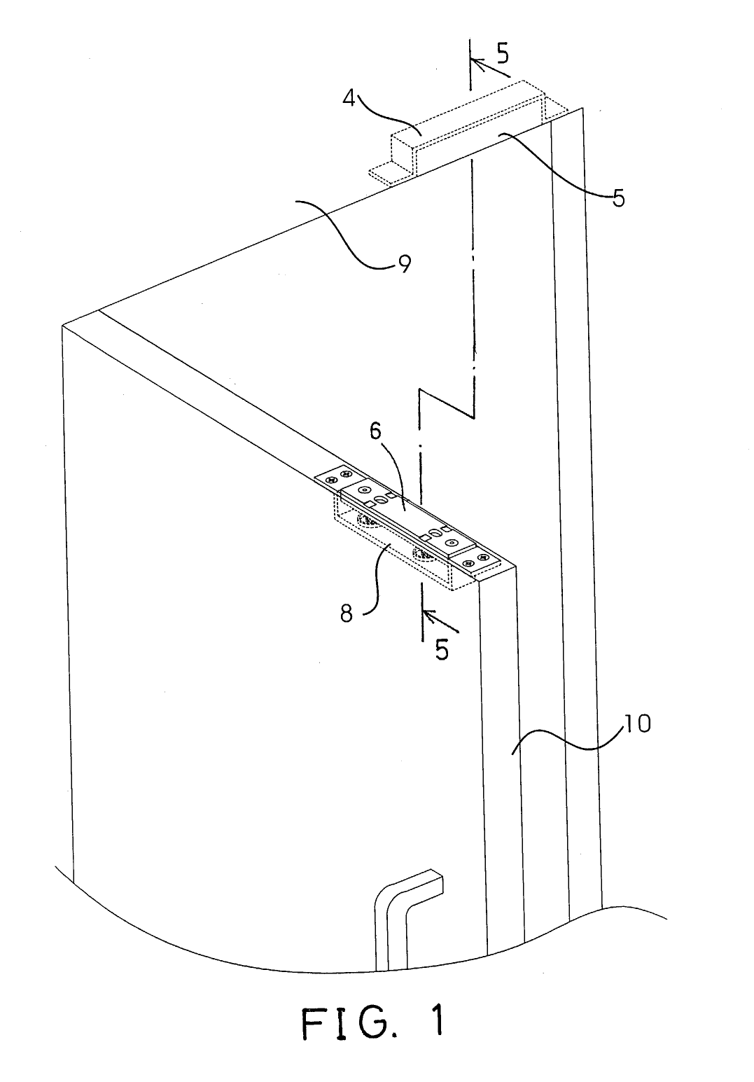

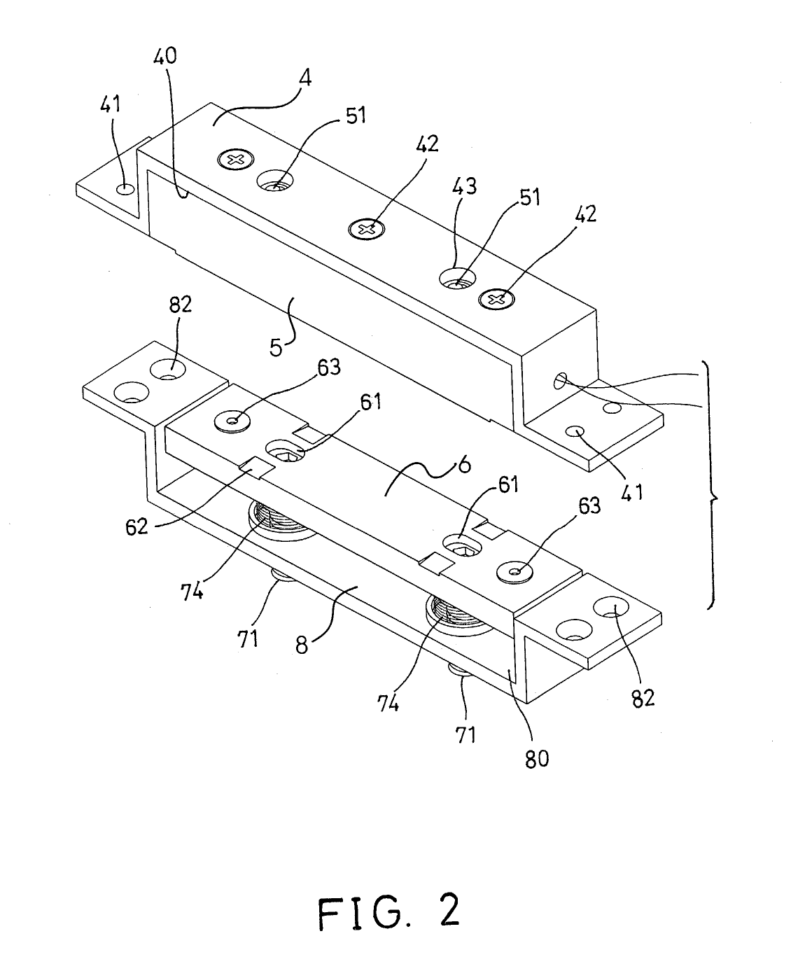

Referring to the drawings, and initially to FIGS. 1 and 2, an electromagnetic lock in accordance with the present invention comprises an electromagnet 5 secured in a receptacle 4 which is to be secured to a door frame 9 or the like, and an armature plate 6 slidably or resiliently attached or received in a housing 8 which is to be secured to a door panel 10 or the like.

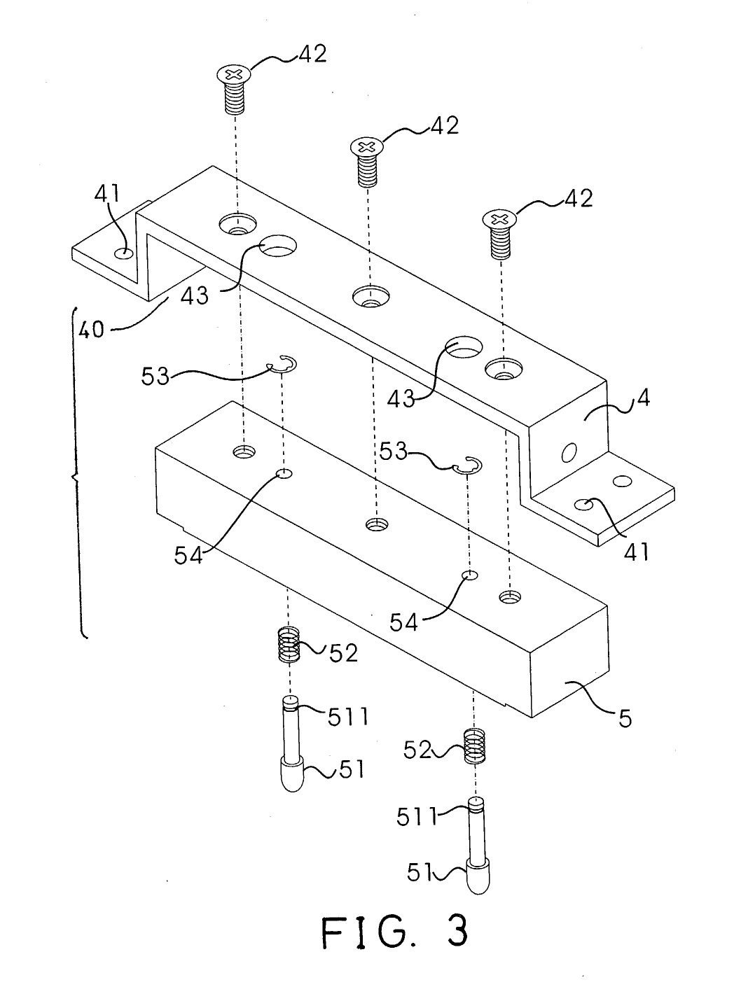

As shown in FIGS. 2, 3, 5, and 9, the receptacle 4 includes a space 40 formed therein to receive the electromagnet 5, and secured to the electromagnet 5 with one or more fasteners 42, or the like, and includes one or more holes 41 formed therein, for receiving such as fasteners (not shown) and for securing to the door frame 9 or the like.

The receptacle 4 includes one or more, such as two orifices 43 formed therein. The electromagnet 5 includes one or more, such as two apertures 54 formed therein, and aligned with the orifices 43 of the receptacle 4. One or more, such as two projections or pins or stops 51 are slidably received in the apertures 54 of the electromagnet 5, and each includes a peripheral groove 511 formed in one end thereof and extended outwardly beyond the electromagnet 5 for engaging with a retaining ring 53.

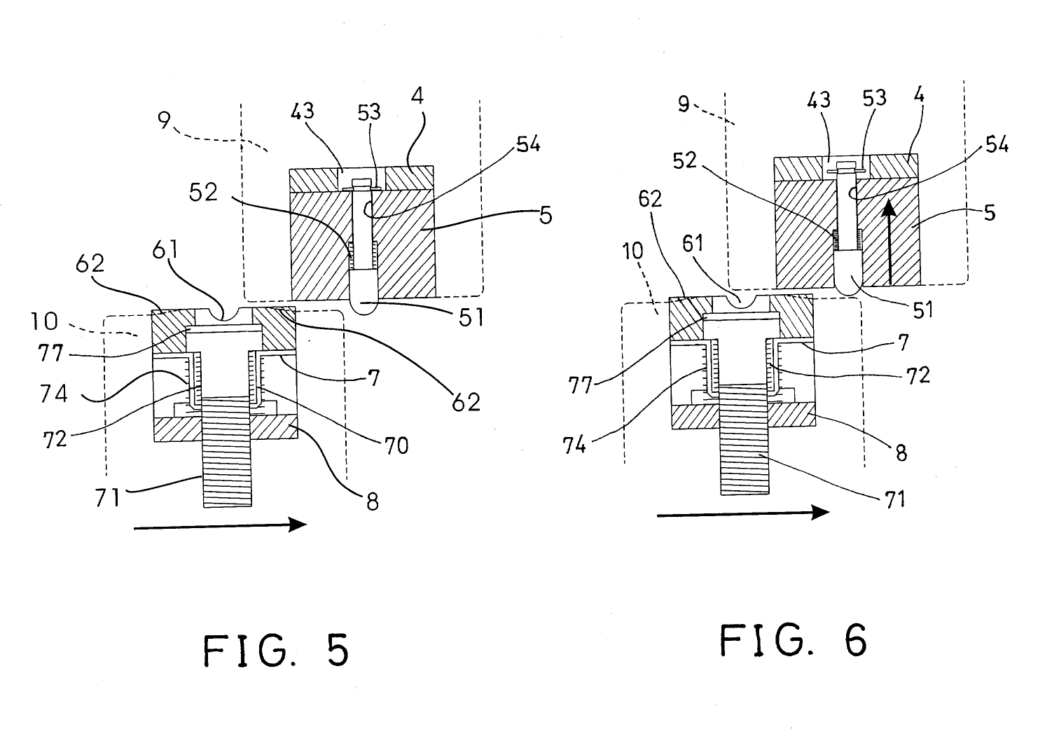

As shown in FIGS. 5-12, the retaining ring 53 may be engaged with the electromagnet 5, to limit the movement of the stop 51 relative to the electromagnet 5. A spring 52 may be engaged onto each of the stops 51, and engaged with the electromagnet 5, for biasing the stops 51 to move slightly and downwardly beyond the electromagnet 5, and to engage with the armature plate 6.

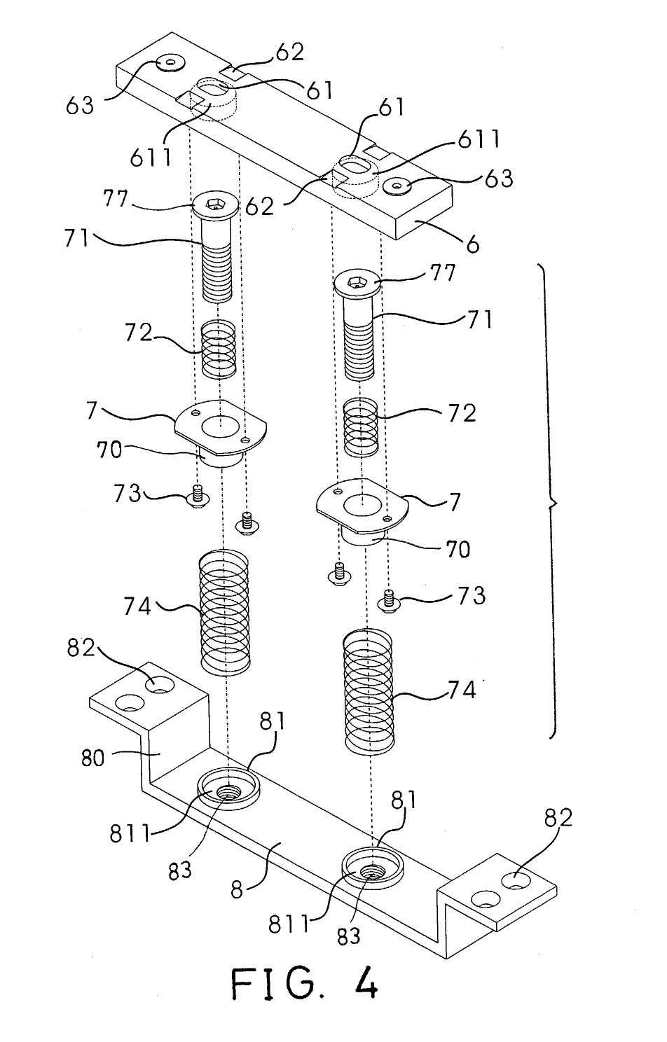

As shown in FIGS. 2, 4, 5, and 9, the housing 8 includes a chamber 80 formed therein to slidably receive the armature plate 5 therein, and includes one or more holes 82 formed therein, for receiving such as fasteners (not shown) and for securing to the door panel 10 or the like.

The housing 8 includes one or more, such as two peripheral fences 81 provided therein, to form or define a recess 811 therein, and includes one or more, such as two screw holes 83 formed therein, such as formed through the housing 8 (FIGS. 5-9), and communicating with the recess 811 thereof.

The armature plate 6 includes one or more, such as two openings 61 formed therein, and one or more, such as two cavities 611 formed therein and communicating with the openings 61 thereof respectively, and one or more, such as two pairs of opposite slopes or ramps 62 formed therein and aligned with the openings 61 thereof respectively.

One or more, such as two boards 7 are secured to the bottom of the armature plate 6 with such as fasteners 73, and each of the boards 7 includes a casing 70 provided thereon or extended downwardly therefrom. One or more, such as two fasteners or guides 71 are engaged through the casings 70 and threaded with the screw holes 83 of the housing 8 respectively, and each may include an enlarged head 77 formed and provided on one end thereof and slidably received in the respective cavities 611 of the armature plate 6 respectively.

As shown in FIGS. 5-12, when the fasteners or guides 71 are threaded with and rotated relative to the screw holes 83 of the housing 8 respectively, the armature plate 6 may be adjusted relative to the housing 8, for allowing the armature plate 6 and the housing 8 to be attached to various door panel 10 or door frame 9. One or more, such as two springs 74 are engaged between the armature plate 6 and the housing 8, for biasing the armature plate 6 away from the bottom or the peripheral fences 81 of the housing 8.

One or more, such as two springs 72 may further be provided and engaged between the stops 71 and the casing 70 or the board 7, for biasing the stops 71 or the heads 77 of the stops 71 toward the openings 61 of the armature plate 6 respectively. The springs 72 are optional and provided to make sure that the heads 77 of the stops 71 may be forced toward or against the armature plate 6.

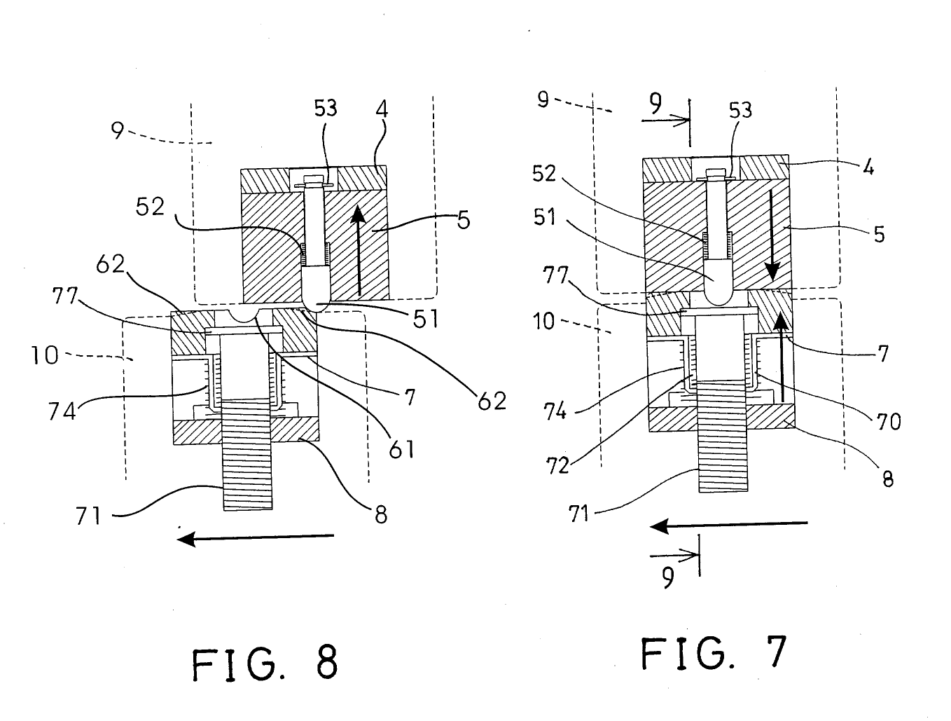

In operation, as shown in FIGS. 5 and 6, when the door panel 10 is moved toward the door frame 9, the stops 51 of the electromagnet 5 may be engaged with the ramps 62 of the armature plate 6, and may be guided to engage into the openings 61 of the armature plate 6 respectively (FIG. 7). As shown in FIGS. 7 and 8, when the door panel 10 is moved away from the door frame 9, the stops 51 of the electromagnet 5 may be moved against the springs 52, for allowing the stops 51 to be disengaged from the openings 61 of the armature plate 6 respectively (FIG. 8), and thus for allowing the door panel 10 to be easily moved away from or opened relative to the door frame 9.

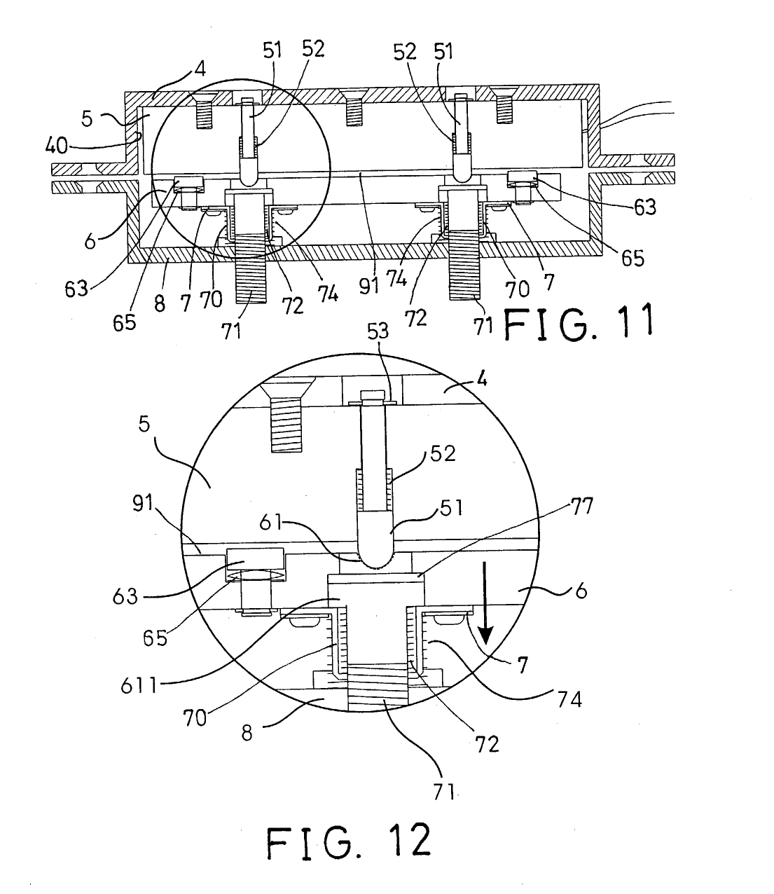

As shown in FIGS. 11, 12, when the electromagnet 5 has not been energized, the armature plate 6 will not be attracted toward the electromagnet 5, such that a gap 91 may be formed between the armature plate 6 and the electromagnet 5, and such that the door panel 10 may be easily moved toward or away from or opened or closed relative to the door frame 9.

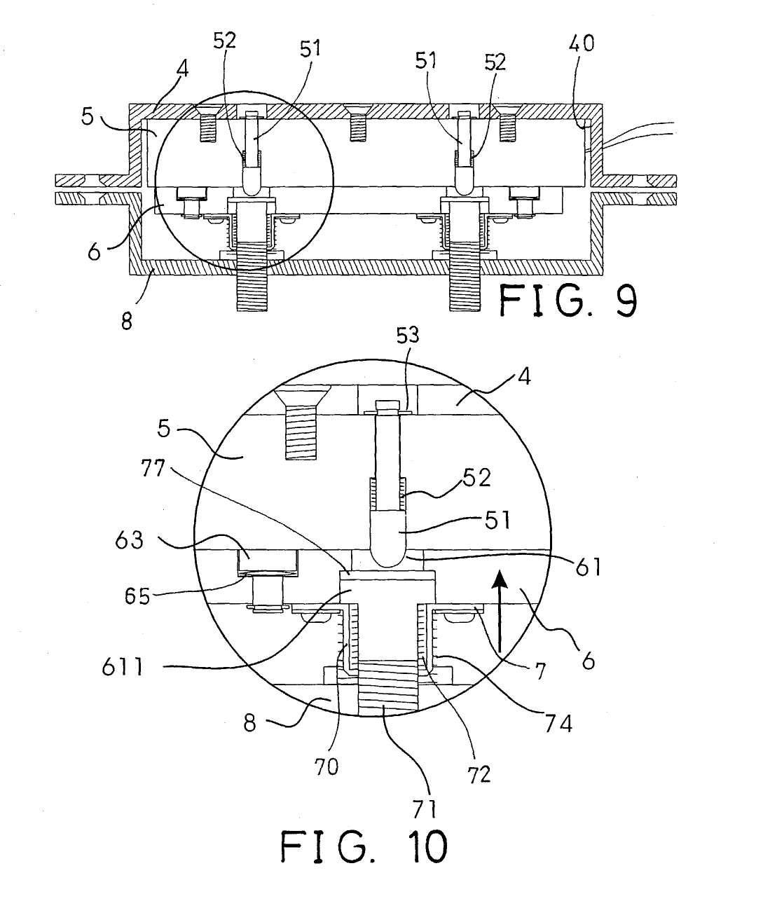

As shown in FIGS. 9 and 10, when the electromagnet 5 is energized, the armature plate 6 will be attracted toward or forced against the electromagnet 5, to solidly attract and attach or secure the armature plate 6 and the electromagnet 5 together, in order to lock the door panel 10 and the door frame 9 together.

As shown in FIGS. 1, 2, 4, and 9-12, the armature plate 6 may further include one or more, such as two pushers 63 slidably received therein, and biased by respective spring members 65 toward the electromagnet 5, and to force the armature plate 6 away from the electromagnet 5 when the electromagnet 5 has not been energized or when the electric power supplied to the electromagnet 5 has been switched off.

Accordingly, the electromagnetic lock in accordance with the present invention includes an electromagnet having one or more spring-biased projections for smoothly engaging with the armature plate, and includes an armature plate having one or more spring-biased guides for effectively engaging with the electromagnet.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electromagnetic lock comprising:
an electromagnet,
two stops provided in said electromagnet and slightly extended downwardly beyond said electromagnet,
a housing including a chamber formed therein,
an armature plate slidably received in said chamber of said housing, and including two openings formed therein, and including an upper portion having two pairs of ramps formed thereon and aligned with said openings thereof respectively, to engage with and to guide said stops of said electromagnet to engage into said openings of said armature plate respectively,
two casings secured to said armature plate and aligned with said openings of said armature plate respectively,
two guides extended through said casings respectively, and each including a first end disposed between said casings and said armature plate respectively, and each including a second end threaded with said housing,
two springs engaged onto said guides respectively, and biased between said armature plate and said housing, for biasing armature plate away from said housing and toward said electromagnet.

2. The electromagnetic lock as claimed in claim 1, wherein said armature plate includes two cavities formed therein and communicating with said openings thereof respectively, and said stops each includes a head provided thereon and received in said cavities of said armature plate respectively.

3. The electromagnetic lock as claimed in claim 1, wherein said housing includes two fences provided on bottom thereof to define two recesses therein and to receive ends of said springs respectively.

4. The electromagnetic lock as claimed in claim 1, wherein said electromagnet includes two apertures formed therein to slidably receive said stops respectively, and two second springs engaged with said stops respectively, to bias said stops slightly downwardly beyond said electromagnet.

5. The electromagnetic lock as claimed in claim 1 further comprising at least one pusher disposed in said armature plate and biased to engage with said electromagnet, for pushing said armature plate away from said electromagnet.
